(19) United States
(12) Patent Application Publication
(10) Pub. No.: US 2011/0184848 A1
(43) Pub. Date: Jul. 28, 2011

(54) Hybrid Exchange And Clearing-Only Market Model

(76) Inventor: Pavel Pinkava, London (GB)

(21) Appl. No.: 13/015,561

(22) Filed: Jan. 27, 2011

Related U.S. Application Data
(60) Provisional application No. 61/299,342, filed on Jan. 28, 2010.

(51) Int. Cl. G06Q 40/00

(52) U.S. Cl. 705/37

(57) ABSTRACT

Modifications can be made to the quotation delivery mechanisms, membership structure, and daily settlement procedures, that govern existing electronic derivatives exchanges to create a “hybrid” business model to perfectly mimic and preserve those important elements of the OTC derivatives business model that attract end-users and banks to these markets. Such upgrades to the traditional exchange business model can be generic and can be applied to existing exchange traded products.

### CROSS REFERENCE TO RELATED APPLICATION

This application claims priority to U.S. Provisional Patent Application Ser. No. 61/299,342 filed Jan. 28, 2010, and entitled “A Hybrid Exchange And Clearing-Only Market Model,” the entire disclosure of which is incorporated herein by reference.

### BACKGROUND

### Analysis of the Problems Posed by OTC Derivatives

The problems posed by Over The Counter (OTC) derivatives markets are not hard to describe since it is universally accepted that the unrestricted use of a particular sub-class of OTC derivative known as Credit Default Swap (CDS) of Asset Backed Securities (ABS) accelerated the irresponsible subprime lending behavior of certain banks. These derivatives were also the leading factor behind the spread of subprime bad debt exposures to other institutions both globally and in the United States.

In addition, the web of contractual links generated by the mainstream OTC derivatives markets is known to have posed a systematic risk, and been a source of moral hazard, in managing the recent banking crisis as banks at the centre of this contractual web were seen as “too big to fail.” This contractual web is generated by bilateral International Swaps and Derivatives Association (ISDA) Master Agreements. The system 100 of FIG. 1 illustrates an exemplary, and highly simplified, version of such a contractual web. Turning to FIG. 1, ISDA Master Agreements are shown forming a two-party contractual relationship between each of the core banks 106 of the system 100. For ease of notation and reference, like items are labeled with the same number. Thus, in FIG. 1, each of the core banks can be thought of as equivalents (for purposes of the illustration of FIG. 1) and, as such, are each labeled with the reference numeral 106. Each of the core banks 106 can have contracted thereto end users, such as the exemplary end user 102. Additionally, large end-users or second tier banks can establish contractual relationships with multiple ones of the core banks 106. Thus, FIG. 1 also illustrates an exemplary second tier bank 104, which is shown as having contractual relationships with at least two of the core banks 106.

Turning to FIG. 2, the exemplary system 200 shown therein illustrates a trade flow pattern in the OTC derivatives market which follows the contractual relationships illustrated in FIG. 1. Additionally, one of the core banks 106 can act in a prime brokerage capacity where the end user can transact with other banks using the name and contractual relationships of its prime broker. The core bank 206 of the system 200 is shown acting in such a prime brokerage capacity, with the end user 102 being able to transact with other core banks 106 using the name and relationship that the core bank 206 has with those other core banks.

As a result of the recent market breakdown, the idea of forcing OTC derivative markets onto exchange has become a hot topic amongst policy makers. In contrast to the OTC derivatives markets, the existing exchange traded futures and options markets are well known for (a) for their operational efficiency and transparency in good times; and (b) for being paragons of low systematic risk in bad times. Thus for example the speed with which the exchange traded positions of Lehman Brothers were liquidated can be contrasted with the slow break-up and unwinding of the rest of their exposures.

These efficiencies and risk reductions are caused primarily by the contractual structure of existing exchange traded futures and options markets. Turning to FIG. 3, the system 300 shown therein illustrates an exemplary contractual structure of an exchange market. As can be seen from the system 300, contractual relationships exist, not between the core banks 106 themselves, but rather between individual core banks and a central exchange and counterparty clearing house 308. End users, such as the exemplary end user 102 can maintain their relationship with a core bank 106, in the manner shown.

Turning to FIG. 4, the system 400 shown therein illustrates an exemplary trade flow in the system 300 of FIG. 3 which, as indicated, is a simplified version of existing exchange traded futures and options markets. In the trade flow illustrated by the system 400, clients, such as the exemplary end user 102, can have direct access to the central auction market 408 of the exchange even though they do not have direct access to the clearing house 308, as illustrated by the system 300 of FIG. 3.

### Why Reforming OTC-Markets is Itself Problematic

In light of the strengths of the traditional exchange traded model it would seem obvious that the best way to reform OTC-markets would be to force them onto exchange. However, amid lobbying from banks, the consensus has shifted towards promoting a central-counterparty-clearing-only “solution” without involving an exchange. As if this level of dilution was not enough many end-users have asked to be exempted from even a central-counterparty-clearing model.

### Why Banks Fear the Traditional Exchange Traded Model

The reason banks prefer a post-trade central-counterparty-clearing-only model is that they fear the alternative. Under the unsophisticated traditional-style exchange traded model all aspects of the market (pre-trade, trade-matching and post-trade) would become open to all comers. Such a model is viewed by banks as potentially making the business of supplying (formerly) OTC derivatives unprofitable on exchange.

For example, the ability of competitors to indulge in “cherry picking” and hence “franchise breaking” of individual bank to end-user relationships, would prevent profitable services provided by a bank from funding the provision of other less profitable offerings by the same bank to the same customer.

The emergence of so called “free-riding” behavior by relatively minor players “fronting” the big banks' bid-ask spreads would result in these (formerly) major liquidity providers failing to secure enough flow business to remain profitable. To clarify, although there is nothing wrong with tighter bid ask spreads due to healthy competitive pressures on exchange, the posting of speculative quotes that are entirely dependent on other liquidity providers' prices is another matter: it is effectively a negative parasitic behaviour that can damage the long term health of the market.

Reduced profitability or increased loss making by the banks that formerly supplied the OTC market would of course be disastrous for liquidity. In this context it must be highlighted that unless there is liquidity a central-counterparty-clearing-house cannot lay-off the risks it inherits from a defaulting member: thus without liquidity a central-counterparty-clearing-house cannot function and it will thereafter become a source of systematic risk rather than a solution to it.

In the worst case under an unsophisticated traditional exchange traded model former OTC liquidity could disappear altogether, undermining the central-counterparty-clearing-house associated with the exchange completely. For this reason a clearing-only solution could paradoxically pose less systematic risk than a failed attempt at a full-blown traditional exchange traded market. No doubt this has been put forward as an argument against full-blown exchange trading by the major banks in their lobbying.

### Similarities Between OTC and EET

Another reason banks don't like exchanges is that many of them do not understand the subtleties of the existing exchange traded model:

For example existing exchange traded products are perceived as fully standardized and transparent yet there are products where an end-user can specify within certain limits, the terms of the trade e.g. the exercise price, expiration date, exercise type, and settlement calculation of so called “flex options.” Of necessity these trades occur apart from the central public auction market and are privately negotiated.

Furthermore “block trades” are routinely permitted in the existing exchange traded model in specified futures, options or combination transaction products. Although such trades are subject to minimum transaction size requirements they too are privately negotiated.

The distinction between the OTC and existing exchange traded liquidity provision models is therefore less clear cut than many bankers believe.

### Why End Users Don't Like Central-Counterparty-Clearing

From the point of view of end-users both a traditional exchange traded model and a central-counterparty-clearing-only model create an equally burdensome overhead. This is because under either alternative they would have to service daily margin calls and this is not the case in the existing OTC markets. Thus for example a derivative that may have previously been recorded using simple hedge accounting would require daily mark to market settlement whether under a full blown traditional exchange traded model or a central-counterparty-clearing-only model. This in turn would lead such end-user firms to have to keep a far greater number of liquid assets on hand then at present, thereby adversely affecting their asset mix and increasing their business risk.

As a result of such concerns, in October 2009 a letter from a “Coalition for Derivatives End-Users” was sent to every member of Congress explaining their concerns about “proposals that would require all OTC derivatives used by business end-users to be centrally cleared, executed on exchanges or cash collateralized or subject end-users to capital charges.” The letter was signed by 171 entities including umbrella organizations as well as individual companies.

### Valuation Issues

OTC derivatives are often presented as being innately complex when for the most part they are not. Thus, for example, one does not have to be a markets wizard to understand that an option to pay USD 15 million in exchange for receiving EUR 10 million on a day three calendar months from today may have value under certain circumstances: a little thought leads to the conclusion that if USD 15 million costs less than EUR 10 million on the foreign exchange market in three months time (or equivalently when EUR 10 million costs more than USD 15 million) the option described will be valuable for the obvious reason that the option owner holds the right to buy something for less than its market price.

Furthermore it is easy to understand the additional concept of agreeing to give up the option described above if EUR/USD happens to trade up beyond 1.5999 between now and the option expiry date. Yet the product described, which is known as a “3 month EUR Call USD Put Struck at 1.50 with reverse knock-out at 1.60,” is considered an “exotic” option despite the fact that its main characteristics can be explained to a layman in relatively straightforward terms. What may not be straightforward to a layman however is to know whether the price an option is being sold for is fair or not. Thus the infamous complexity of derivatives arises mostly around valuation issues. Working out a price of an “exotic” option is relatively more complex than working out the price of a simpler instrument.

### SUMMARY

Modifications can be made to the quotation delivery mechanisms, membership structure, and daily settlement procedures, that govern existing electronic derivatives exchanges to create a “hybrid” business model to perfectly mimic and preserve those important elements of the OTC derivatives business model that attract end-users and banks to these markets. Such upgrades to the traditional exchange business model can be generic and can be applied to existing exchange traded products.

Accordingly, in one embodiment, an efficient platform can be created for delivering exchange tradable derivatives in an OTC-like format for any products for which this is appropriate.

In another embodiment, access to central clearing for all market participants in the existing OTC market, including end-users, can be provided. Such access to end-users can be optionally provided without them having to make any margin calls.

In a further embodiment, the profitability of the major liquidity providing banks can be preserved on the new “hybrid” platform.

In a yet further embodiment, systematic risk can be reduced by removing the need for existing OTC markets. None of the advantages of traditional exchange trading need be lost on the new “hybrid” platform, which can increase the potential for regulatory oversight of these markets.

In a still further embodiment, a platform which displays the best aspects of the traditional exchange traded model and the existing OTC market simultaneously can be provided such that these aspects are coordinated into a single system onto which the entire existing OTC market can be transferred. Such a single system can increase both the transparency and the general level of understanding of derivatives, such that as a side effect improved accounting and taxation rules regarding derivatives can result.

### DESCRIPTION OF THE DRAWINGS

FIG. 1 is a simplified schematic representing the OTC market contractual structure;

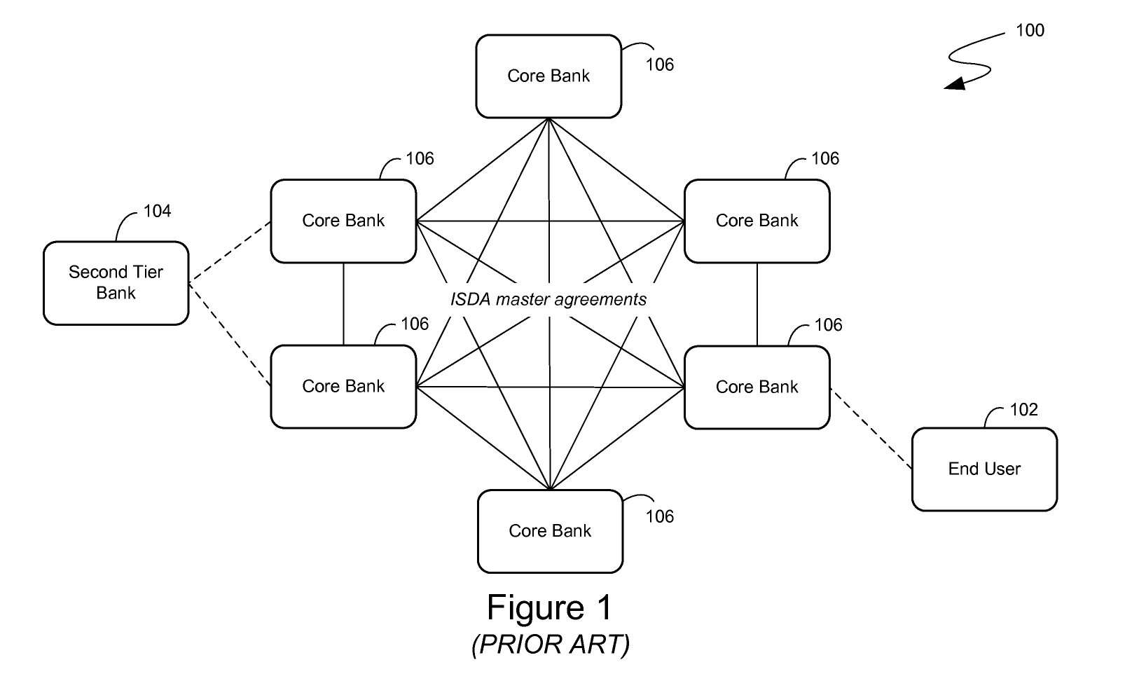

FIG. 2 is a simplified schematic representing the OTC market trade flow pattern;

FIG. 3 is a simplified schematic representing the existing futures market contractual structure;

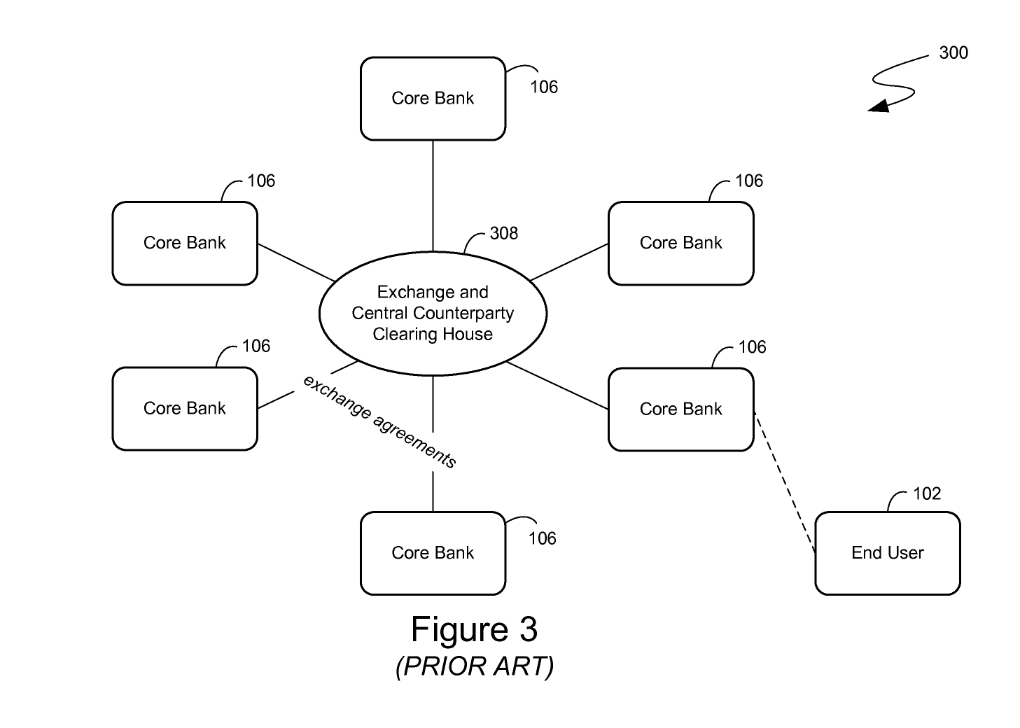

FIG. 4 is a simplified schematic representing the existing futures market trade flow pattern;

FIG. 5 is a simplified schematic representation of the hybrid market contractual structure;

FIG. 6 is a simplified schematic representation of the hybrid market trade flow structure for on-the-run central market products; and

FIG. 7 is a simplified schematic representing a specialized computing device that can implement the hybrid market.

### DETAILED DESCRIPTION

The assumption that the interests of existing OTC market users cannot be fully aligned with the interests of reformers and regulators is wrong.

A first step towards a solution to the aforementioned apparently conflicted positions is for the sell-side banks to explicitly pay to maintain their “franchise” by posting initial and daily variation margin calls to the central-counterparty-clearing-house on behalf of their end-user customers. To formalize this, various categories of participation in the exchange can be established.

Guaranteed Accounts—These could be end-users (such as the 171 entities mentioned above and even minor financial markets entities such as smaller funds) that could have their initial margin and daily variation margin calls posted for them by their guaranteeing member.

Full Members—These could be entities such as banks and other major financial institutions, including some of the largest funds, with the capacity and desire to post initial margin and daily variation margin calls on their own positions.

Guaranteeing Full Members—These could be a class of full members who in addition to servicing their own positions could also post initial margin and daily variation margin calls on any positions held by the guaranteed accounts they support. In one embodiment, only sufficiently capitalized full members who honored the exchange's market making requirements could achieve guaranteeing member status. In other words these could be analogous to the “sell-side” banks of today.

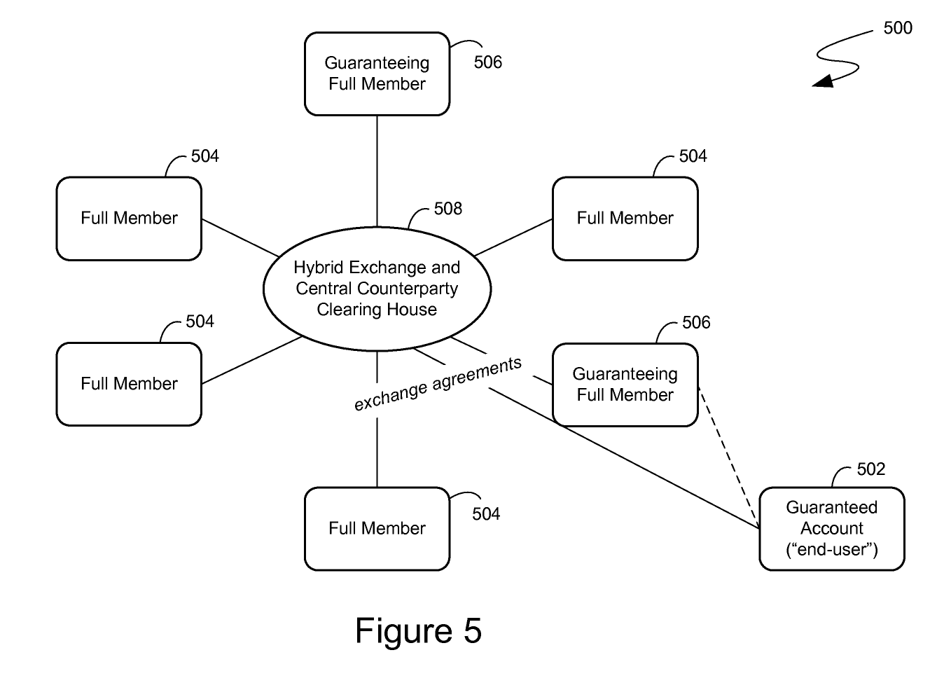

Turning to FIG. 5, the system 500 shown therein illustrates an exemplary, and simplified, set of contractual relationships contemplated by the above-described hybrid market. For example, an end-user can have a guaranteed account 502 which can have its initial margin, and subsequent daily variation margin, calls posted for it by a guaranteeing full member 506, as illustrated by the dashed line in FIG. 5. Nevertheless, the guaranteed account 502 can have an agreement with the hybrid exchange 508 independently of a guaranteeing full member 506, as illustrated by the solid lines of FIG. 5.

The details of this new solution have many admirable features. For example, the solution allows all the participants in the existing OTC derivatives market to develop direct links to the exchange's central-counterparty-clearing-house, such as shown by the solid lines of FIG. 5. The contract between a guaranteed account entity and its guaranteeing full member entity can be a market standard document drafted by the exchange 508 and requiring the registration of all end-user entities directly with the central-counterparty-clearing-house. Because it can define the relationship between a liquidity provider and their customer such a contract could play an analogous role to the ISDA Master Agreement in a classic OTC market structure.

As the guaranteed accounts 502 could be directly visible at the central-counterparty-clearing-house 508 level it could be easy for regulators, accountants and auditors to check the exposure and/or performance of each end-user's derivatives position and to collect accurate data on the whole market. This could quickly lead to improved accounting rules regarding derivatives.

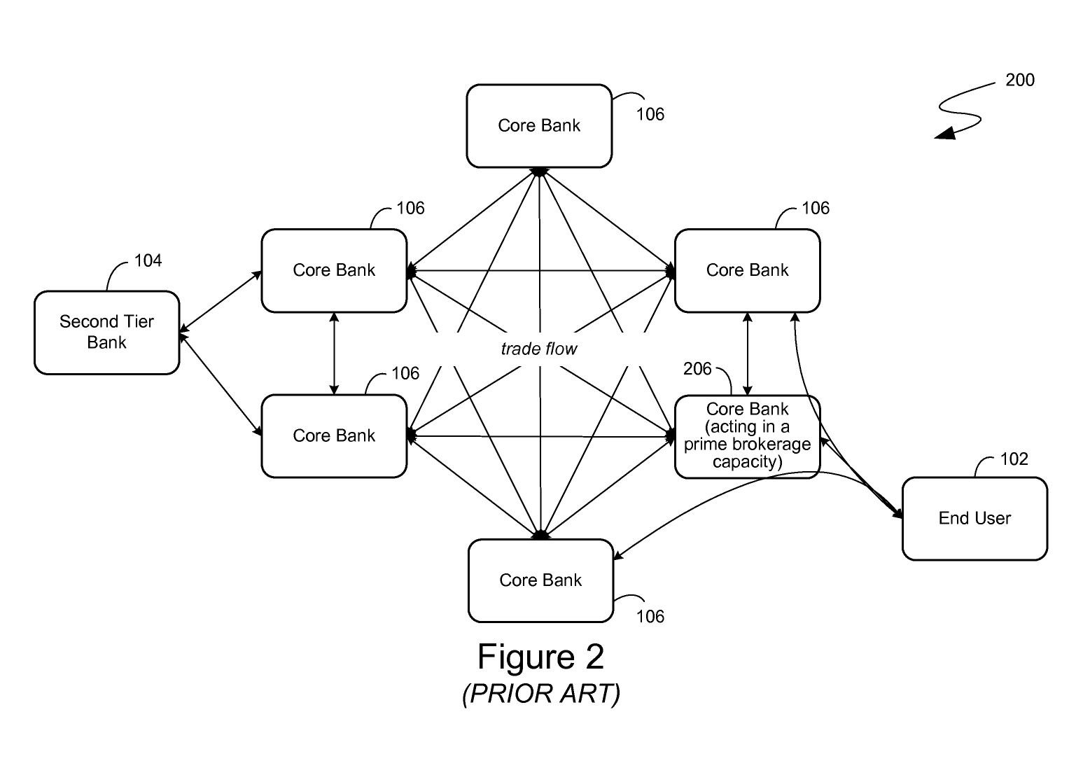

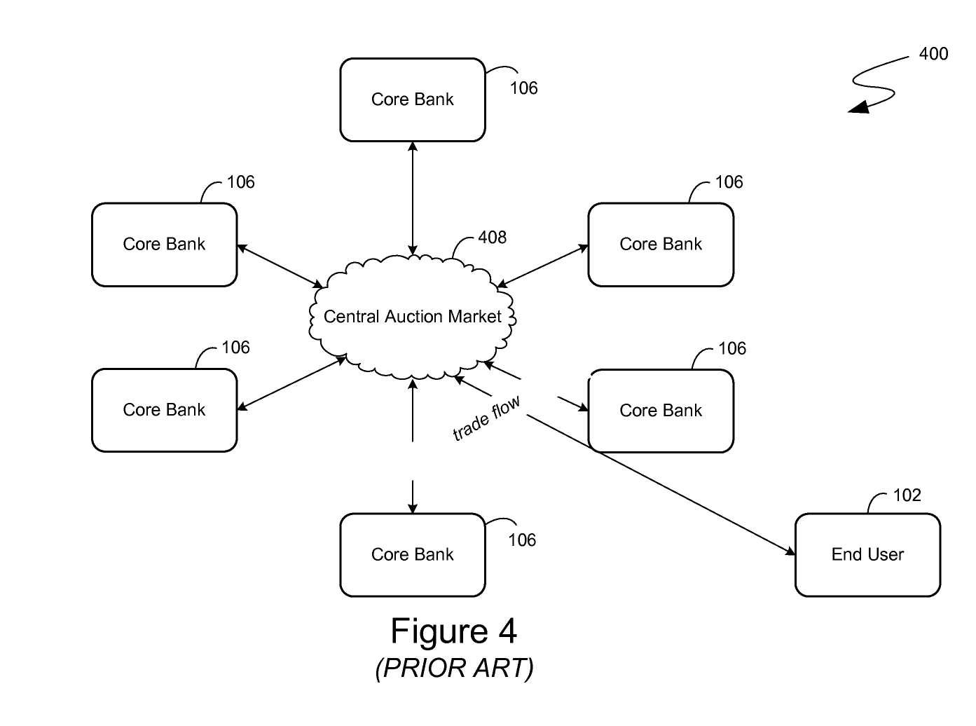

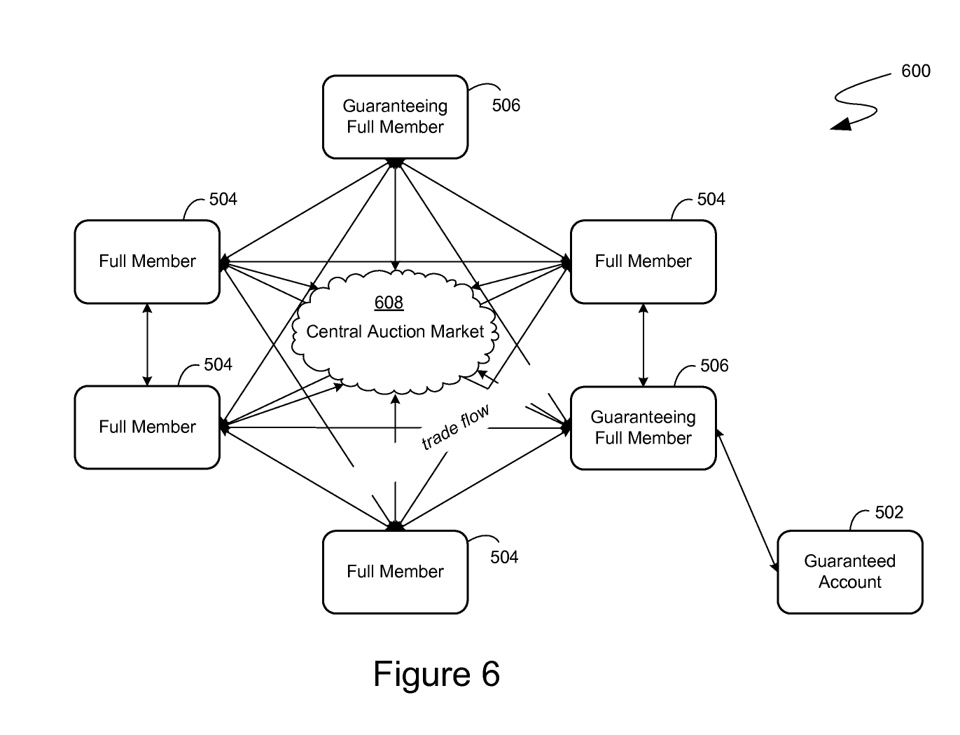

Another exemplary admirable feature of the above-described solution is the existence of a “hybrid model” since full members can trade on an exchange like central market for on-the-run listed products (analogous to the situation illustrated in FIG. 4) or directly for more exotic products listed for clearing but not trading (analogous to the situation illustrated in FIG. 2), whilst direct bank to client liquidity provision relationships are also preserved. For example, and turning to FIG. 6, the system 600 shown therein illustrates an exemplary trade flow enabled by the system 500 of FIG. 5. As shown in FIG. 6, each of the full members 504 and the guaranteeing full members 506 can trade with the central auction market 608, such as for on-the-run listed products and they can, simultaneously, each trade directly with one another for more exotic products that are listed for clearing, but not trading. As such, direct bank to client liquidity relationships, such as the relationship between a guaranteeing full member 506 and the guaranteed account 502 shown in FIG. 6, are preserved.

Guaranteeing full members could be obliged to make markets in the central order book for some of the most liquid contracts, and full members could be required to trade via the order book whenever appropriate. Such would apply, for example, for on-the-run standard sized deals, but not necessarily for very large deals, or for unusual dates, such as those not on the 1w, 2w, 3w, 1m, 2m, . . . , 1y, 2y etc cycle that is standard to some products.

The extent to which an end-user would seek or could be allowed direct access to other liquidity providing members, or even to the unrestricted central market for relevant products, could be the subject of negotiation with their guaranteeing full member. Such negotiation might involve, for example, broader access in exchange for an end-user promising to supply some or all of its own margin. However the principal liquidity provision relationship could remain via their guaranteeing full member, as shown in FIG. 6.

Yet another exemplary admirable feature of the above-described hybrid approach is that each position taken in a traded derivative element (e.g. a position in single cash flow within a swap) can be maintained separately when held in an end-user's guaranteed account. Each element can generate a net accumulated daily variation margin balance that must be settled with the end-user once that element expires. Hence at expiry either: (1) the end-user can be paid from margin accumulated at the central-counterparty-clearing-house on its behalf; or (2) the end-user can have to repay variation margin owed to its guaranteeing member i.e. margin that was previously supplied by the member and consumed by the central-counterparty-clearing-house.

The result is that a payment identical to a classic OTC contract could be made on the relevant settlement date either to or from the end-user, respectively. This is provided, of course, that the traded element has been designed to carry the appropriate exposure in and of itself.

This explains why the proposed model is being presented as an apparently OTC-like market at its periphery, i.e. because end-users experiences are unchanged even though their positions are connected to the central-counterparty-clearing-house.

Yet another exemplary admirable feature of the above-described hybrid approach is that upon a failure to pay a variation margin call the central-counterparty-clearing-house can close out positions in a member or guaranteed account at the exchange using initial margin to finance losses just as in existing futures markets. This is of course equivalent to close out netting under an ISDA Master Agreement:

If an end-user defaults on a payment then the accumulated variation margin already paid in by its guaranteeing member can be recovered by the guaranteeing member privately. Thus not only can the consequences ultimately be borne by the guarantor, as is only proper, but the immediate impact can be minor on all other members and therefore can pose a relatively low systematic risk.

If a guaranteeing member itself defaults then, unlike the OTC situation the end-user can be at once protected because any mark to market profits to date are held at the central-counterparty-clearing-house on its behalf as explained above.

Alternatively to avoid closing out positions the entire guaranteed account could be transferred to a new guarantor perhaps under a prearranged fall back agreement with another full member. The new guarantor could have to replace initial margin that was supplied by the old guarantor. The other details of the relationship between the new guarantor and the defaulting old guarantor could vary from case to case subject to negotiations and the extent to which one guarantor insured the other etc.

Yet another exemplary admirable feature of the above-described hybrid approach is how relatively light the burden could be for full members when posting margin for clients. A derivative being margined in the guaranteed account could in most instances have been supplied by the guaranteeing full member itself. In such cases the guaranteeing member can hold a mirroring contract with the central-counterparty-clearing-house.

When its client goes into a net accumulated loss the bank can post variation margin to its end-user's guaranteed account. However these funds can be returned to the member as variation margin profits on its own mirroring position. The net impact can therefore simply be that mark to market profits on the bank's own position, that would ordinarily have been received as variation margin under an traditional exchange traded style model, could remain unrealized and instead could merely be recorded in the guaranteed account as accumulated variation margin due from the client to the bank. As explained the end-user will eventually have to repay variation margin owed to its guaranteeing member unless it defaults in the manner described. Also as explained above regulators, accountants and auditors can easily confirm the level of accumulated margin owed to the bank. Indeed, from the bank's point of view given accumulated margin is recorded for each traded derivative element separately, it could become trivial to split this into current assets (due within one year) and long-term assets. Finally, the bank's risk management department can use this information to decide what size of counterparty hedge the bank may require e.g. a credit default swap with another bank held as a hedge against the impact of the end-user defaulting.

When its client makes a profit the variation margin paid into the end-user's guaranteed account can ultimately have come from the member paying margin on its own mirroring position. Thus mark to market losses on the bank's own position can always be realized, but this is no worse than in a clearing-only model.

In the other cases where the derivative position being margined in the guaranteed account has not been supplied by the guaranteeing full member the bank could likely be in the situation described above. The guaranteeing full member could not therefore be fully burdened because of the bank's ability to collect margin from its client. With an end-user supplying some or all of their own margin (but perhaps less frequently than daily for the client's operational convenience) the relationship could therefore be analogous to derivatives prime broking in the existing OTC model or to the calling of collateral within other traditional OTC relationships.

### Description of Additional Method

Two of the issues raised above implicitly concern the bid/ask spread. Specifically: how to discourage the emergence of destructive “free-riding” behavior in any central market with an active order book and how to handle the issue of calculating fair values for the many “complex” derivatives?

To a large extent the former point has already been addressed through the introduction of guaranteed accounts that are tied directly to their liquidity providing full members. Also a set “tic size” as used in the current exchange traded model can address this point as its effect can be to set a threshold beyond which “fronting” is not possible, i.e. through the creation of a minimum bid/ask spread.

As to the latter point, this can be an issue for the central-counterparty-clearing-house which can set correct daily settlement prices. It may be imagined that keeping on top of this issue could require a very significant overhead of staff trained in quantitative finance, however this is not the case where a liquid exchange traded market exists. Thus, for example, in order to market fairly, our existing futures exchanges need not necessarily concern themselves with fair value calculations but can merely observe the relevant market. Assuming the market is rational, a fair settlement price can be observed directly on the exchange at the close.

Given that futures exchanges have traditionally set a single daily closing price it is easy to imagine that finding fair values for “complex” derivatives is about discovering the single price at which exposure to such instruments could be fairly obtained from a liquidity provider. However, to think this is to misunderstand the supply process for such derivatives: a bid/ask spread can be required to cover the liquidity provider's cost of doing business and in an ideal system should not be ignored. By way of analogy, setting a fair bid/ask spread can be as important to a liquidity providing bank as a means of covering its cost of doing business as is the maintaining a margin between wholesale and retail prices to a retailer. To be clear, the derivative provider's cost of doing business is their cost of hedging.

Quantitative finance theory can be frequently used by academically trained staff within banks to value derivatives under the artificial simplifying assumption that there are no hedging costs. However using such models can be only a first step. The theoretical values they generate can serve as a starting point for valuations, and in order to cover hedging costs dealers can add bid/ask spreads as well as biasing input factors, e.g. by including a volatility smile in valuations.

### Respecting the Bid/Ask Spread

In one embodiment, bids and asks submitted as part of the end of day closing and settlement calculation can be not processed into single settlement prices (as in an traditional exchange traded model) but can be processed into separate “bid settlement prices” and “ask settlement prices.”

In another embodiment, variation margin can be called on long positions by reference to bid settlement prices and variation margin can be called on short positions by reference to ask settlement prices.

In yet another embodiment, only the closing bids and asks of guaranteeing full members' can be part of the settlement price calculation, when the hybrid market model is implemented.

Under the method explained above, “free-riders” holding positions overnight could suffer mark to market variation margin losses equal to the cost of closing out their position with the real liquidity providers: the guaranteeing full members can be the real liquidity providers and only their closing prices can form the basis of the end of day settlement process. In short, “free-riding” could no longer be free at least for overnight position holders. As for day traders the process of squaring up before the close would inevitably feed order flow into overnight liquidity providers in any case.

### Link to First Method

The existence of the privilege set out above would underline the importance of guaranteeing full members' responsibilities as previously described.

Marking longs and shorts to market separately, as set out above, can impact the hybrid model only modestly by potentially putting a liquidity providing bank in a slightly different situation than that originally described above. This is because the bank could have to pay away variation margin losses equal to the bid/ask spread on open client positions. Thus compared to the originally described situation banks could no longer be able to immediately realize liquidity provision profits up front, e.g. if a bank had traded in on the bid and out on the offer with different clients in an unchanged market.

Hence bid/ask spread earnings could only be realized once variation margin was returned under the method set out above. Such a restriction would fit with the fact that as described above a guaranteeing liquidity providing bank can be exposed to end-user default so the bid/ask profit in this case may not be safe before the relevant deal element has matured.

### Preferred Embodiments

Given there is a multiplicity of OTC derivatives markets for different product types there would naturally be a multiplicity of preferred embodiments. However the current invention would work well with the inventions set out in U.S. patent application Ser. No. 11/172,739 filed Jul. 1, 2005 and Ser. No. 11/179,382 filed Jul. 12, 2005 entitled “Trading And Settling Enhancements To The Standard Electronic Futures Exchange Market Model Leading To Novel Derivatives Including On Exchange ISDA Type Credit Derivatives And Entirely New Recovery Products Including Novel Options On These” and “Trading And Settling Enhancements To The Standard Electronic Futures Exchange Market Model Leading To Novel Derivatives Including On Exchange ISDA Type Interest Rate Derivatives And Second Generation Bond Like Futures Based In Part Or Entirely On Them” respectively.

How to Offer OTC-like CDS Whilst Actually Trading x-CDS

As utilized herein, the term “x-CDS” will be utilized to refer to the electronic exchange traded ISDA-type credit default swaps set out in U.S. patent application Ser. No. 11/172,739 filed Jul. 1, 2005 to distinguish them from OTC CDS.

In one embodiment, described further below, banks can offer OTC-like credit default swaps to end-users whilst actually trading x-CDS with them. One difference between OTC CDS and x-CDS is that whereas running premium due in future periods is cancelled after a credit event in the OTC format CDS it can be effectively accelerated in the x-CDS format.

More specifically, because CDS are traded instruments, an important feature of these contracts is their market price. The focus should be on the way the fair price/premium fluctuates as market conditions vary over time and how this affects the value of existing deals. The focus need not be on the part of the swap that gives insurance against default, although ironically the price in question is the premium that market participants are willing to pay for the insurance element of the swap. This premium can be paid as coupon or as coupon plus upfront (for example via (1) coupons payable quarterly in arrears with the coupon rate quoted per annum; plus perhaps (2) an upfront part payment that is either positive or negative relative to coupon payments). Obviously since the total value of the default insurance being bought can't be affected by the method used to pay for it, the coupon rate will be lower when the protection buyer (i.e. coupon payer) also makes an upfront payment but will be higher when they receive an upfront payment (that is, they make a negative payment). When there is no upfront payment the CDS is said to be a “par CDS” and the coupon rate is called the “par coupon rate” or “par swap rate.”

Due to the way CDS are designed there is normally a close relationship between the par coupon rate quoted in the market at any one time and the credit spread in the debt markets at the same time—the par rate is therefore often quoted by market makers.

In 2009 OTC CDS were redesigned and relaunched in a pair of initiatives known as the “big bang” and the “small bang” for North American and European referenced debt respectively. The trouble with the classic market was that each new deal was struck in the manner described above and as the par rate fluctuated many deals with different coupons would be agreed. This in turn meant that multiple fair valuation calculations would be required at each end of day settlement, even for what was a single CDS exposure type. The redesigned OTC CDS are simply classic OTC CDS but restricted to only a handful of predefined standard coupon rates: in redesigned OTC CDS, coupon rates can only take on values chosen from a few preset choices and new deals will be agreed at the standard coupon nearest, but no longer always equal to, the par rate. The limited variety of deal ticket coupons reduces the number of distinct deals to be valued and hence the number of end of day calculations required at the clearing house. However this improvement comes at a cost, namely that: (a) new deals are no longer struck at par which means hedgers may need to make upfront payments as well as coupon payments; and (b) hedgers may fail to understand the link between upfront premium and the par rate, and by extension the link with the credit spread they know and understand. Making a product less user friendly just to make it more easily clearable is an unfortunate compromise.

To avoid such compromise, one aspect of x-CDSes relevant to the descriptions below is a fuller utilization of the potential of the electronic trading process, specifically by use of computer based mapping-algorithms. These mapping-algorithms can allow quoted x-swaps to be broken down into futures-like components that can be traded and cleared in the tried and trusted electronic traded environment. For the front office trader the products can appear to mimic existing OTC-swaps, whereas the rest of the process can be as efficient and robust as existing futures markets.

Another outcome of this approach can be that x-swaps can be easily understood by analogy as they have the same relationship to OTC-swaps as exchange traded futures have to OTC-forwards. More specifically, because x-CDS can be made up of futures-like components (the x-CDS coupons) they can automatically benefit from the characteristics of futures.

Thus, x-CDS can be clearable because their futures-like components are clearable.

Additionally, unlike OTC CDS deals, but like futures, x-CDS can trade without reference to any previous deal price. Whereas OTC-forwards remain locked in at their original deal price, futures contracts undergo daily legal variation of their price coupled with cash payments in the form of variation margin gains or losses. As truly exchange traded products x-CDS, like futures, can effectively maintain their original deal rate without actually keeping their original deal price.

Because futures do not support upfront payments, x-CDS need not either. Thus in a manner superior to OTC CDS, an x-CDS can trade as a pure par coupon rate maintaining its relationship to the underlying credit spread and doing so without the need for any market standard formula to calculate fair upfront payments. By comparison with the above features of x-CDS, the redesigned OTC CDS with their limited choice of pre-set standard coupon rates and lack of hedger utility are a very inelegant solution.

As if this was not enough, another feature of x-CDS can be that the design naturally generates system implied x-CDS forward par rates and hence can increase trading opportunities and can stimulate the creation of a full credit term structure.

As already mentioned the coupon rate of an x-CDS need not be a fixed deal price but can be a volatile market price subject to daily variation, coupled with daily variation margin gains or losses.

Additionally, x-CDS can accrue coupons in an unusual way in that the coupon due can be drawn down gradually over the entire quarterly period for which the coupon is effective.

Lastly, after a credit event both x-CDS and OTC CDS can pay out equal amounts in default compensation. However, coupon payments due after the credit event can be treated differently. Whereas the coupon payments of an OTC CDS can be cancelled, those of an x-CDS can be accelerated, with payments for all forward periods becoming due immediately. The last point can be an important difference and can, under the same market conditions, tend to cause par coupon rates quoted in x-CDS format to be below those quoted in traditional OTC CDS format.

### Example Scenario

Imagine a bank is a guaranteeing full member of the hybrid market as described above and that in its role as a liquidity provider it sells a 1 year CDS on XYZ Corp in OTC-like format to an end-user's guaranteed account. Imagine that the deal is struck at a par premium of 0.60% per annum and in a notional amount of USD 10 million. It is to be booked as a zero upfront premium deal (i.e. at 0.60% running premium), which is easy to achieve in terms of x-CDS coupons as follows:

A “basic position” providing exposure to default insurance is as follows: book four quarterly x-CDS coupons each at the agreed price of 0.60% per annum (i.e. approximately 0.15% of notional depending on day counts), each in the agreed size of USD 10 million. Long positions are booked to the end-user's guaranteed account and short positions to the bank's own account in favor of the dealer.

An “over-hedge” position (to deal with coupon acceleration in x-CDS) as follows: book an additional over-hedge of positions each at a price of 0.00% per annum and in sizes based on calculations using an assumed recovery rate. Assuming a 40% recovery rate, this leads to sizes of USD 75,000 for the first quarterly x-CDS coupon, USD 50,000 for the second quarterly x-CDS coupon, USD 25,000 for the third quarterly x-CDS coupon and zero for the fourth quarterly x-CDS coupon. Long positions are booked to the end-user's guaranteed account and short positions to the bank's own account in favor of the dealer.

The reader should not be concerned that a recovery rate assumption is needed to generate the correct x-CDS over-hedge since it is frequently necessary to make recovery rate assumptions when handling calculations even in the existing OTC CDS markets. Thus, for example, the fair relationship between the par premium agreed when a deal is struck and actual booking terms, including any upfront payment, also requires a recovery rate assumption. Yet, the formula for calculating the fair upfront payment is so standard that it is readily available on systems such as Bloomberg.

### Checking the Over-hedge is Correct

The calculations in this example are based on the simplifying assumption that credit events occur only at the end of whole periods. It would not be hard to lift this assumption but it would make the over-hedge more complex (and dynamic) as hedging of the risk of acceleration of the un-accrued portion of the effective OTC CDS coupon, which amount changes from day to day, could be required. Thus, presenting the full detail would make the example unnecessarily complicated and under the simplification stated the example can confirm the equivalence of the 1 year OTC-like trade and the x-CDS used to book it quite easily, by considering all possible outcomes: (1) no credit event, (2) a credit event at the end of the last coupon period, (3) a credit event at the end of the third coupon period, (4) a credit event at the end of the second coupon period and (5) a credit event at the end of the first coupon period.

### Equivalence Under No Credit Event

Recall that in the hybrid model each accumulated daily variation margin balance can be settled by the end-user only once the relevant element has expired. In this case the elements can be x-CDS coupons which if no credit event has occurred can be drawn down to zero on their normal expiry date. Under these circumstances the end-user can pay the bank accumulated margin on the USD 10 million basic position equal to the margin call generated by the x-CDS coupon price having dropped from 0.15% to zero. The over-hedge positions may not generate a margin call by expiry time since these were transferred at zero price in the first place. Notice that the amount due under the x-CDS positions can be the same amount due under the OTC CDS contract and can be paid at the same time as each x-CDS coupon normal expiry date is the same as the due date of the corresponding OTC coupon.

### Equivalence Under a Credit Event at the End of the Last Coupon Period

As far as the fourth x-CDS coupon is concerned USD 10 million can be held in the basic position and there need not be an additional position in the over-hedge. If a credit event occurs at the end of the fourth coupon period the x-CDS coupon position can provide the same amount of default insurance as under the OTC CDS contract i.e. they both can supply the notional amount of USD 10 million.

### Equivalence Under a Credit Event at the End of the Third Coupon Period

As far as the third x-CDS coupon is concerned USD 10 million can be held in the basic position and there can be an additional position of USD 25,000 in the over-hedge. If a credit event occurs at the end of the third coupon period the fourth coupon could be accelerated, resulting in a payment of USD 15,000 becoming due on the x-CDS, i.e. one coupon of 0.15% of notional has been accelerated. However at the assumed 40% recovery rate the over-hedge can neutralize this by generating exactly the USD 15,000 required. Meanwhile the basic x-CDS coupon position can provide the same amount of default insurance as under the OTC CDS contract as before.

### Equivalence Under a Credit Event at the End of the Second Coupon Period

As far as the second x-CDS coupon is concerned USD 10 million can be held in the basic position and there can be an additional position of USD 50,000 in the over-hedge. If a credit event occurs at the end of the second coupon period the third and fourth coupons could be accelerated, resulting in a payment of USD 30,000 becoming due on the x-CDS, i.e. two coupons of 0.15% of notional each have been accelerated. However at the assumed 40% recovery rate the over-hedge can neutralize this by generating exactly the USD 30,000 required. Meanwhile the basic x-CDS coupon position can provide the same amount of default insurance as under the OTC CDS contract as before.

### Equivalence Under a Credit Event at the End of the First Coupon Period

As far as the first x-CDS coupon is concerned USD 10 million can be held in the basic position and there can be an additional position of USD 75,000 in the over-hedge. If a credit event occurs at the end of the second coupon period the second, third and fourth coupons could be accelerated, resulting in a payment of USD 45,000 becoming due on the x-CDS, i.e. three coupons of 0.15% of notional each have been accelerated. However at the assumed 40% recovery rate the over-hedge can neutralize this by generating exactly the USD 45,000 required. Meanwhile the basic x-CDS coupon position will provide the same amount of default insurance as under the OTC CDS contract as before.

Concluding Remarks on this Example Trade Embodiment

The above description demonstrates how a bank can offer fully clearable classic OTC-like CDS to its customers via trading x-CDS within a hybrid exchange model of the type presented above. The recovery rate assumption that can be made by the bank represents merely a residual exposure to the actually realized recovery rate. Nonetheless banks can develop strategies for managing these residuals.

Additionally, the process can also work in the opposite direction to that presented in the example. Thus, the market in x-CDS could be the dominant venue for price discovery and banks could price liquidity provision of OTC-like CDS dependent on where the x-CDS market was trading. In other words the 0.60% per annum offered to the end-user in the example could typically not be a starting point. Instead, it could be the result of a break even calculation by the bank and could represent a level where: a) the end-user's overspend on the basic x-CDS long position, which could be booked above the level where x-CDS were trading in the main market, would fully fund and b) the end-user's underspend on the over-hedge x-CDS long position, which can be always booked at zero cost and therefore below the level where x-CDS were trading in the main market.

### Implementation on a Computing Device

As will be recognized by those skilled in the art, the above-described markets, techniques and strategies can be implemented by specialized computing devices specifically designed to implement the above-described embodiments. Traditionally, such specialized computing devices would be obtained by executing, on readily available general-purpose computing devices, one or more sets of computer-executable instructions that, when executed, cause the general-purpose computing device to become a specialized computing device.

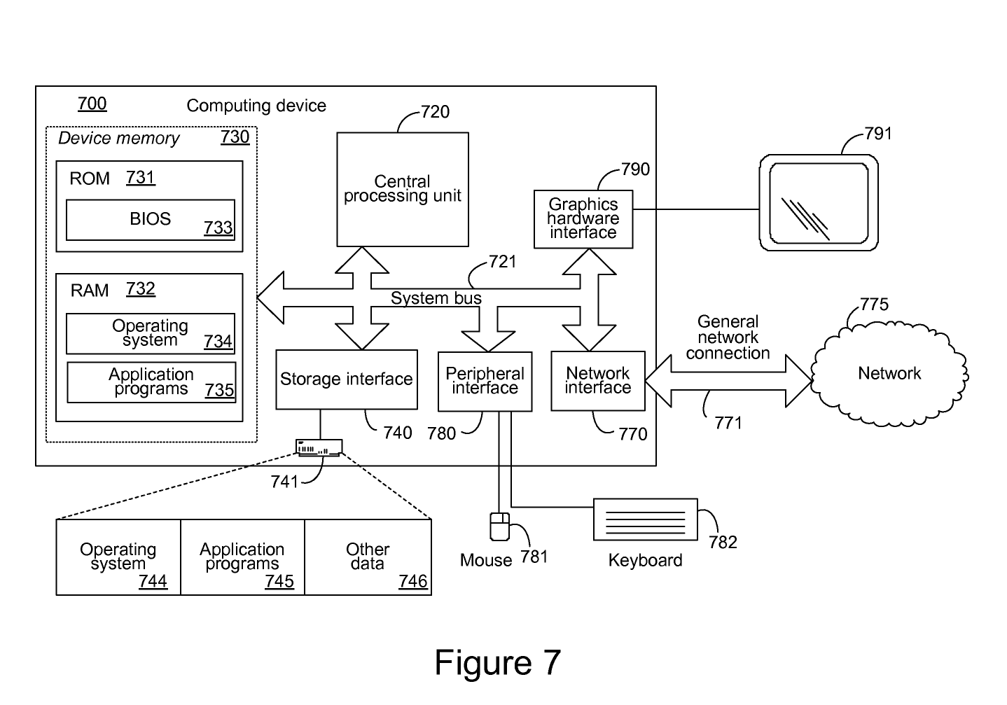

Turning to FIG. 7, an exemplary computing device 700 is illustrated upon which, and in conjunction with which, the above-described embodiments can be implemented. The exemplary computing device 700 of FIG. 7 can include, but is not limited to, one or more central processing units (CPUs) 720, a device memory 730, that can include Random Access Memory (RAM) 732, and a system bus 721 that couples various system components including the memory 730 to the processing unit 720. The system bus 721 may be any of several types of bus structures including a memory bus or memory controller, a peripheral bus, and a local bus using any of a variety of bus architectures. The computing device 700 can optionally include graphics hardware, such as for the display of visual user interfaces, including, but not limited to, a graphics hardware interface 790 and a display device 791. Additionally, the computing device 700 can also include user interface elements, including, but not limited to a mouse 781 and a keyboard 782 that can be utilized by a user to generate input in response to the interface displayed via the display device 791. The user interface elements can be communicationally coupled to the system bus 721 via a peripheral interface 780 and use of the user interface elements by the user for the purposes of providing user input can generate signals that can be carried by the system bus 721 to computer-executable instructions executing as part of the operating system 734 which can, in turn, provide such user input to the operating system 734 or application programs 735, as appropriate.

The computing device 700 also typically includes computer readable media, which can include any available media that can be accessed by computing device 700 and includes both volatile and nonvolatile media and removable and non-removable media. By way of example, and not limitation, computer readable media may comprise computer storage media and communication media. Computer storage media includes media implemented in any method or technology for storage of information such as computer readable instructions, data structures, program modules or other data. Communication media typically embodies computer readable instructions, data structures, program modules or other data in a modulated data signal such as a carrier wave or other transport mechanism and includes any information delivery media. Combinations of the any of the above should also be included within the scope of computer readable media.

The system memory 730 includes computer storage media in the form of volatile and/or nonvolatile memory such as Read Only Memory (ROM) 731 and the aforementioned RAM 732. A basic input/output system 733 (BIOS), containing the basic routines that help to transfer information between elements within computing device 700, such as during start-up, is typically stored in ROM 731. RAM 732 typically contains data and/or program modules that are immediately accessible to and/or presently being operated on by processing unit 720. By way of example, and not limitation, FIG. 7 illustrates the operating system 734 along with other programs 735.

The computing device 700 may also include other removable/non-removable, volatile/nonvolatile computer storage media. By way of example only, FIG. 7 illustrates the hard disk drive 741 that reads from or writes to non-removable, nonvolatile magnetic media. The hard disk drive 741 is typically connected to the system bus 721 through a storage interface 740.

The drives and their associated computer storage media discussed above and illustrated in FIG. 7, provide storage of computer readable instructions, data structures, program modules and other data for the computing device 700. In FIG. 7, for example, hard disk drive 741 is illustrated as storing operating system 744, application programs 745, and other data 746. Note that these components can either be the same as or different from operating system 734 and application programs 735 as executing in the RAM 732. Operating system 744 and application programs 745 are given different numbers to illustrate that, at a minimum, they are different copies.

The computing device 700 can also operate in a networked environment using logical connections to one or more remote computers. The computing device 700 is illustrated as being connected to the general network connection 771 through a network interface or adapter 770 which is, in turn, connected to the system bus 721. In a networked environment, program modules depicted relative to the computing device 700, or portions or peripherals thereof, may be stored in the memory of one or more other computing devices that are communicatively coupled to the computing device 700 through the general network connection 771. It will be appreciated that the network connections shown are exemplary and other means of establishing a communications link between computing devices may be used.

As can be seen from the above descriptions, a hybrid exchange and clearing-only market model has been presented. In view of the many possible variations of the subject matter described herein, we claim as our invention all such embodiments as may come within the scope of the following claims and equivalents thereto.

We claim:

1. A method of supporting liquidity provision relationships and generating derivative performance akin to those found in existing over the counter derivative markets, the method comprising the steps of:
providing, to market participants, direct membership to an exchange that comprises a clearing house for the market participants;
allocating one membership category, from among membership categories comprising an end-user member and a guaranteeing member, to each new participant, from among the market participants, as the each new participant joins the exchange;
restricting end-user member participants from accessing a central market associated with the exchange;
granting, to at least two guaranteeing member participants, private liquidity provider privileges to quote markets in a specified set of products autonomously from the central market; and
only allowing end-user member participants to join the exchange if they are contractually tied to at least one guaranteeing member participant, the allowing being based on standard terms provided by the exchange, wherein the at least two guaranteeing member participants to which the private liquidity provider privileges were granted include the at least one guaranteeing member participant that is contractually tied to the end-user member participants that are allowed to join the exchange;
wherein, for each individual derivative position held by an end-user member participant, any daily variation margin payments due to the end-user member participant are retained by a clearing house and eventual disbursement from the clearing house, of any variation margin balance due on the each individual derivative position, occurs only once the each individual derivative position is closed or expires; and
wherein further the at least one guaranteeing member participant that is contractually tied to the end-user member participant is responsible for posting any margin required to maintain the each individual derivative position, such that any variation margin balance paid by the at least one guaranteeing member participant is repaid to it by the end-user member participant, as well as any initial margin being returned to the at least one guaranteeing member participant by the clearing house, once the each individual derivative position is closed or expires.

2. The method of claim 1, wherein at least some of the market participants are licensed by the exchange to act as agents or brokers within parameters set by the exchange.

3. The method of claim 1, wherein a market participant may join the exchange more than once being assigned the end-user member category, each joining being tied to a different guaranteeing member participant.

4. The method of claim 3, wherein each market participant has assigned to it a unique identifier that allows the exchange to monitor and report aggregate positions of the each market participant, and wherein further each market participant must disclose, when attempting to join the exchange and have assigned the end-user membership category, if they already have joined the exchange at least once and have been assigned the end-user membership category.

5. The method of claim 3, wherein, if a market participant has been assigned the end-user member category more than once, a variation margin payment default by one such assigned end-user member category is considered a default by each of them.

6. The method of claim 1, wherein private liquidity providing privileges are balanced by the exchange by imposing compensating central market maker obligations on selected participants, such that the selected participants must post bids and offers in specified products in the central market.

7. The method of claim 1, wherein the clearing house records individual transactions of the end user member participants as compared to other participants, the records comprising an identity of the guaranteeing member participant associated with each position.

8. The method of claim 1, wherein the at least one guaranteeing member participant must report a violating end-user member participant for not repaying variation margin when due; and wherein further the reporting the violating end-user member participant triggers sanctions against the violating end-user member participant.

9. The method of claim 1, wherein members with private liquidity provider privileges provide other members with access to a broader range of products than those listed for continuous central trading at the exchange.

10. A method for daily settlement of products, the method comprising the steps of:
allocating, to a specified set of market participants, a daily settlement market maker status for a specified set of products;
receiving bids and offers by each allocated daily settlement market maker as part of an end-of-day closing and settlement calculation for each relevant product;
processing the bids and the offers separately to create a distinct bid settlement price and ask settlement price for each product of the specified set of products;
calculating variation margin calls on long positions by reference to the bid settlement price; and
calculating variation margin calls on short positions by reference to the ask settlement price.

11. The method of claim 10, wherein private liquidity providing privileges are provided to the specified set of market participants that are allocated the daily settlement market maker status.

12. One or more computer-readable media having computer-executable instructions for supporting liquidity provision relationships and generating derivative performance akin to those found in existing over the counter derivative markets, the computer-executable instructions performing steps comprising:
providing, to market participants, direct membership to an exchange that comprises a clearing house for the market participants;
allocating one membership category, from among membership categories comprising an end-user member and a guaranteeing member, to each new participant, from among the market participants, as the each new participant joins the exchange;
restricting end-user member participants from accessing a central market associated with the exchange;
granting, to at least two guaranteeing member participants, private liquidity provider privileges to quote markets in a specified set of products autonomously from the central market; and
only allowing end-user member participants to join the exchange if they are contractually tied to at least one guaranteeing member participant, the allowing being based on standard terms provided by the exchange, wherein the at least two guaranteeing member participants to which the private liquidity provider privileges were granted include the at least one guaranteeing member participant that is contractually tied to the end-user member participants that are allowed to join the exchange;
wherein, for each individual derivative position held by an end-user member participant, any daily variation margin payments due to the end-user member participant are retained by a clearing house and eventual disbursement from the clearing house, of any variation margin balance due on the each individual derivative position, occurs only once the each individual derivative position is closed or expires; and
wherein further the at least one guaranteeing member participant that is contractually tied to the end-user member participant is responsible for posting any margin required to maintain the each individual derivative position, such that any variation margin balance paid by the at least one guaranteeing member participant is repaid to it by the end-user member participant, as well as any initial margin being returned to the at least one guaranteeing member participant by the clearing house, once the each individual derivative position is closed or expires.

13. The computer-readable medium of claim 12, wherein at least some of the market participants are licensed by the exchange to act as agents or brokers within parameters set by the exchange.

14. The computer-readable medium of claim 12, wherein a market participant may join the exchange more than once being assigned the end-user member category, each joining being tied to a different guaranteeing member participant.

15. The computer-readable medium of claim 14, wherein each market participant has assigned to it a unique identifier that allows the exchange to monitor and report aggregate positions of the each market participant, and wherein further each market participant must disclose, when attempting to join the exchange and have assigned the end-user membership category, if they already have joined the exchange at least once and have been assigned the end-user membership category.

16. The computer-readable medium of claim 14, wherein, if a market participant has been assigned the end-user member category more than once, a variation margin payment default by one such assigned end-user member category is considered a default by each of them.

17. The computer-readable medium of claim 12, wherein private liquidity providing privileges are balanced by the exchange by imposing compensating central market maker obligations on selected participants, such that the selected participants must post bids and offers in specified products in the central market.

18. The computer-readable medium of claim 12, wherein the clearing house records individual transactions of the end user member participants as compared to other participants, the records comprising an identity of the guaranteeing member participant associated with each position.

19. The computer-readable medium of claim 12, wherein the at least one guaranteeing member participant must report a violating end-user member participant for not repaying variation margin when due; and wherein further the reporting the violating end-user member participant triggers sanctions against the violating end-user member participant.

20. The computer-readable medium of claim 12, wherein members with private liquidity provider privileges provide other members with access to a broader range of products than those listed for continuous central trading at the exchange.
